(19) United States
(12) Patent Application Publication
(10) Pub. No.: US 2011/0171025 A1
(43) Pub. Date: Jul. 14, 2011

(54) Wind Turbine Blade and Turbine Rotor

(75) Inventors: Richard F. LEVINE, Poughkeepsie, NY (US); Russell M. TENCER, New York, NY (US); Sander MERTENS, Voorburg (NL)

(73) Assignee: WIND PRODUCTS INC., New York, NY (US)

(21) Appl. No.: 13/004,459

(22) Filed: Jan. 11, 2011

Related U.S. Application Data
(60) Provisional application No. 61/294,367, filed on Jan. 12, 2010.

(51) Int. Cl. F03D 3/06

(52) U.S. Cl. 416/1; 416/223 R; 416/244 R

(57) ABSTRACT

Wind turbine rotors and wind turbine blades having the startup capability of a drag-type turbine and the increased tip speed of a lift-type turbine are provided. The rotor includes a plurality of elongated blades, each of the blades having a first portion mounted to a mast at a first radial distance from the mast and a second portion mounted to the mast at a second radial distance from the mast, less than the first radial distance. Each blade includes a first chord length, a second chord length, and a third chord length between the first and second chord length. The third chord length is less than the first chord length and less than the second chord length. The blades may be helical. Aspects of the invention provide a self-starting, Darrieus-type rotor for enhanced wind energy capture.

### CROSS-REFERENCE TO RELATED APPLICATION

This application claims priority from pending U.S. Provisional Patent Application 61/294,367, filed on Jan. 12, 2010, the disclosure of which is included by reference herein in its entirety.

### BACKGROUND OF THE INVENTION

1. Field of the Invention

The present invention relates, generally, to wind turbine blades and wind turbine rotors, particularly, to vertical-axis wind turbine blades and rotors having variable blade diameter and/or varying blade chord length.

2. Description of Related Art

In the early 21^{st} century, the acute recognition of the decline in the availability of fossil fuels and the limitation of fossil fuels for providing global energy needs continues to direct attention to the development of alternate energy sources. One source of renewable energy receiving increased attention is the plentiful and renewable supply of wind energy, that is, the conversion of wind energy to electrical energy from the rotation of wind turbines powered by wind.

As is known in the art, there are two classes of wind turbines: (1) the horizontal-axis wind turbine (HAWT) having propeller-type blades; and (2) the vertical-axis wind turbine (VAWT) having vertically-oriented blades. Though effective in many locations, due to their large blade diameters, HAWTs are typically not as appropriate in congested or crowded environments, such as, near and around buildings in an urban environment. The typically smaller, more compact design of the VAWT is more conducive to mounting and operation on homes, factories, and other buildings.

VAWT technology is characterized by two approaches: (1) the drag-type or Savonius-type wind turbine, as exemplified, by U.S. Pat. No. 1,697,574 of Savonius, and (2) the lift-type or Darrieus-type wind turbine, as exemplified, by U.S. Pat. No. 1,835,018 of Darrieus. Each of these VAWTs has different performance characteristics. For example, the Savonius wind turbine, characterized by bucket-type rotors, is effective in “self-starting,” that is, accelerating the turbine from zero speed, for example, without the need for ancillary starting equipment and the power the starting equipment requires. In addition, Savonius wind turbines are by their nature limited in rotational speed to the speed of the wind impacting the turbine; that is, the Savonius turbine can only turn as fast as the wind blows. As is known in the art, the ratio of the speed of the tip of the turbine blade to the speed of the impelling wind is referred to as the “tip speed ratio” (TSR). For the Savonius-type turbine, the TSR is limited to the maximum TSR of 1.0 or slightly higher, and typically the TSR of Savonius turbines is less than 1.0. Since the speed of a Savonius turbine is limited, the energy that can be extracted from wind by a Savonius turbine is also limited.

Darrieus-type turbines or lift-type turbines benefit from the effect of aerodynamic lift whereby Darrieus turbines can typically rotate faster than the speed of the impelling wind. For example, Darrieus turbines can have TSRs of greater than unity and can reach TSRs of 4.0 or more. Accordingly, typically, the larger kinetic energy of the Darrieus turbine can harvest much more energy from wind than a Savonius turbine. However, Darrieus-type turbines typically cannot self-start like Savonius-type turbines. Typically, some form of starter motor, and its consequent energy, must be provided to accelerate a Darrieus turbine to operational speed. In addition, Darrieus-type turbines can be difficult to control at high speed to prevent the turbine from over-speeding. In addition, the structure of typical Darrieus-type turbine rotors can be prone to excitation of natural frequencies that can make them unstable.

Aspects of the present invention provide a blade and a rotor for a VAWT that overcome the disadvantages of the prior art.

### SUMMARY OF ASPECTS OF THE INVENTION

Embodiments and aspects of the present invention provide wind turbine rotors, wind turbine blades, and methods for operating wind turbine rotors that combine the benefits and advantages of drag-type turbines and lift-type turbines in a single device. Embodiments of the invention provide turbine blades of varying radial position and/or the varying chord length that provide unique startup and performance characteristics that are not found in the prior art.

A first embodiment of the invention is a wind turbine rotor comprising or including a central elongated mast; and a plurality of elongated blades, each of the plurality of blades having a first portion and a second portion, the first portion mounted to the mast at a first radial distance from the mast and the second portion mounted to the mast at a second radial distance from the mast, less than the first radial distance. In one aspect, the first portion may comprise a first end portion of each of the plurality of elongated blades, for example, a first extremity, and the second portion may comprise a second end portion, for example, a second extremity, of each of the plurality of elongated blades opposite the first end portion. In one aspect, each of the plurality of elongated blades may be substantially straight blades.

A second embodiment of the invention is a method of operating a wind turbine, the method comprising or including exposing a first portion of each of a plurality of blades positioned at a first radial distance from a central rotatable mast to wind wherein each of the plurality of blades is accelerated by the wind from substantially zero tangential velocity to a first tangential velocity greater than zero; and exposing a second portion of each of a plurality the blades positioned at a second radial distance, greater than the first radial distance, from the central rotatable mast to the wind wherein each of the plurality of blades is accelerated by the wind to a second tangential velocity greater than the first tangential velocity. In one aspect, the method is practiced with little or no energy input other than the wind, for example, substantially no energy input other than the wind. In one aspect, the first tangential velocity comprises less than 5 rpm, for example, substantially zero rpm, wherein the method comprises a “passive startup” of the turbine rotor (see below). The method may also include minimizing over speeding of the plurality of blades with the first portion of each of a plurality of blades positioned at a first radial distance from a central rotatable mast.

Another embodiment of the present invention is wind turbine rotor comprising or including a central elongated mast; and a plurality of elongated blades, each of the plurality of elongated blades having a first portion and a second portion, the first portion mounted to the mast at a first radial distance from the mast and the second portion mounted to the mast at a second radial distance from the mast, less than the first radial distance; wherein each of the plurality of elongated blades comprises a first chord length in the first portion, a second chord length in the second portion, and a third chord length between the first portion and the second portion, the third chord length less than the first chord length and less than the second chord length. In one aspect, the first portion may be a first end portion of each of the plurality of elongated blades, for example, an extremity of the blade, and the second portion may be a second end portion of each of the plurality of elongated blades opposite the first end portion. In another aspect, each of the plurality of blades comprises a first uniform taper from the first chord length to the third chord length and a second uniform taper from the second chord length to the third chord length.

Another embodiment of the invention is an elongated wind turbine blade comprising or including a first portion having a first chord length, a second portion having a second chord length, and a third portion positioned between the first portion and the second portion having a third chord length, the third chord length less than the first chord length and less than the second chord length. The first chord length may be less than the second chord length. In one aspect, the first portion of the blade may be a first end portion or extremity of the blade and the second portion may be a second end portion or extremity of the blade opposite the first end portion. In another aspect, the blade may include a first uniform taper from the first chord length to the third chord length and a second uniform taper from the second chord length to the third chord length. For example, both the first uniform taper and the second uniform taper may range from about 0.5 degrees to about 5 degrees.

Another embodiment of the invention is a wind turbine rotor comprising or including a central elongated mast; a plurality of substantially radial supports mounted to the mast; and a plurality of elongated blades mounted to the plurality of radial supports; wherein at least one of the plurality of the radial supports is configured to provide at least some lift to the wind turbine rotor. For example, in one aspect, the at least one of the plurality, typically, three or more, of radial supports comprise an airfoil having a cambered or a non-cambered shape.

A further embodiment of the invention is a method of operating a wind turbine comprising or including: rotatably mounting one of the wind turbine rotors recited above to a structure, for example, to a generator; and exposing the wind turbine rotor to a source of wind to accelerate rotation of the wind turbine rotor from a first rotational speed to a second rotational speed, greater than the first rotational speed; wherein the second portion of at least one of the plurality of blades mounted at a second radial distance contributes at least some torque to the acceleration of the turbine rotor. In one aspect, the first rotational speed comprises less than 5 rpm, for example, substantially zero rpm, wherein the method comprises a passive startup of the turbine rotor. According to aspects of the invention, “passive startup” may comprise a “self starting” function whereby little or no external or ancillary power, other than wind, need be provided to accelerate the turbine from substantially zero speed to a higher speed, for example, to operational speed; for instance, the turbine may accelerate from substantially zero speed to a higher speed under the influence of wind alone. Though according to some aspects of the invention, the passive startup function may be contributed to or provided substantially by the portion of the rotor having the second, or smaller, radial distance, in other aspects of the invention, the passive start-up may also be contributed to by other portions of the turbine, for example, by a portion at the first radial distance, or a radial distance greater than the second radial distance, may contribute to passive startup.

Methods of mounting and operating turbine rotors and turbine blades are also provided.

Details of these embodiments and aspects of the invention, as well as further aspects of the invention, will become more readily apparent upon review of the following drawings and the accompanying claims.

### BRIEF DESCRIPTION OF THE FIGURES

The subject matter that is regarded as the invention is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is an elevation view of a wind turbine having a rotor and turbine blade according to aspects of the invention.

FIG. 2 is an elevation view of the wind turbine rotor shown in FIG. 1 as indicated by Detail 2 in FIG. 1.

FIG. 3 is a top plan view of the wind turbine rotor shown in FIG. 2.

FIG. 4 is a detailed view of the rotor mounting shown in FIG. 2 as indicated by Detail 4 in FIG. 2.

FIG. 5A is a representative axial view of the rotor blade shown in FIG. 2 as indicated by views 5A-5A in FIG. 2.

FIG. 5B is a representative axial view of the rotor blade shown in FIG. 2 as indicated by views 5B-5B in FIG. 2.

FIG. 6 is a developed view of the rotor blade shown in FIG. 2 prior to bending into a helical shape.

FIG. 7 is an elevation view of another wind turbine rotor according to an embodiment of the invention.

FIG. 8 is a top plan view of the wind turbine rotor shown in FIG. 7.

FIG. 9 is an elevation view of a further wind turbine rotor according to an embodiment of the invention.

FIG. 10 is a top plan view of the wind turbine rotor shown in FIG. 9.

FIG. 11 is a representative cross sectional view of a rotor blade according to an embodiment of the invention.

FIG. 12 is another representative cross sectional view of a rotor blade according to another embodiment of the invention.

FIG. 13 is perspective view of a wind turbine assembly according to another aspect of the invention.

FIG. 14 is side elevation view of the wind turbine assembly shown in FIG. 13.

FIG. 15 is top plan view of the wind turbine assembly shown in FIG. 13.

FIG. 16 is a curve of the power achievable at a given wind speed according to one aspect of the invention

### DETAILED DESCRIPTION OF FIGURES

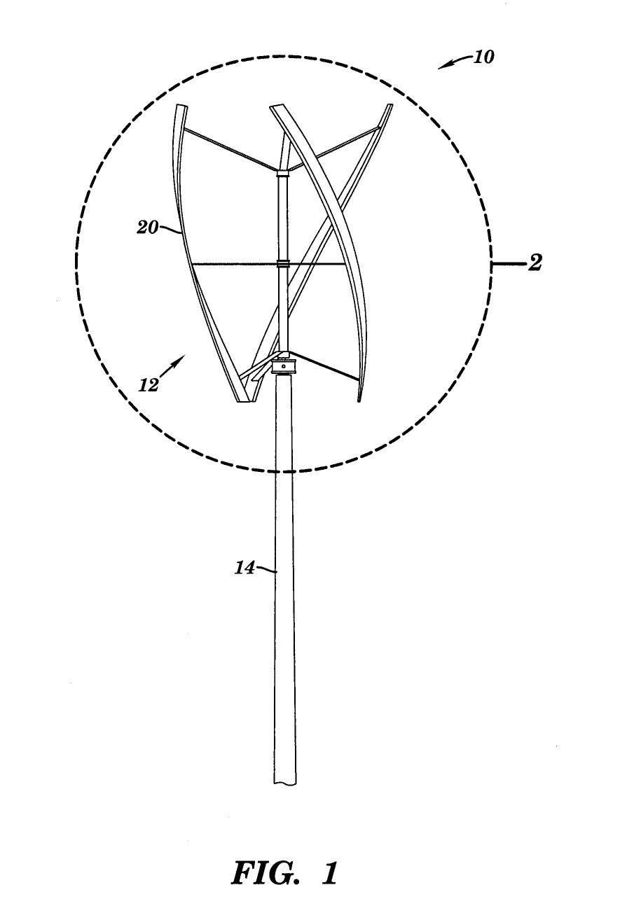

The details and scope of the aspects of the present invention can best be understood upon review of the attached figures and their following descriptions. FIG. 1 is an elevation view of a wind turbine 10 having a rotor 12 having turbine blades 20 according to aspects of the invention. As is typical of the art, rotor 12 may be mounted on a pole, pyramid, or stanchion 14 in order to expose rotor 12 to the desired wind currents in order to generate the maximum amount of electrical energy. According to aspects of the invention, rotor 12 may be mounted on a stanchion 14 or may be mounted on any suitable structure, for example, to a rooftop of a building or home by conventional means, to expose rotor 12 to maximum wind energy.

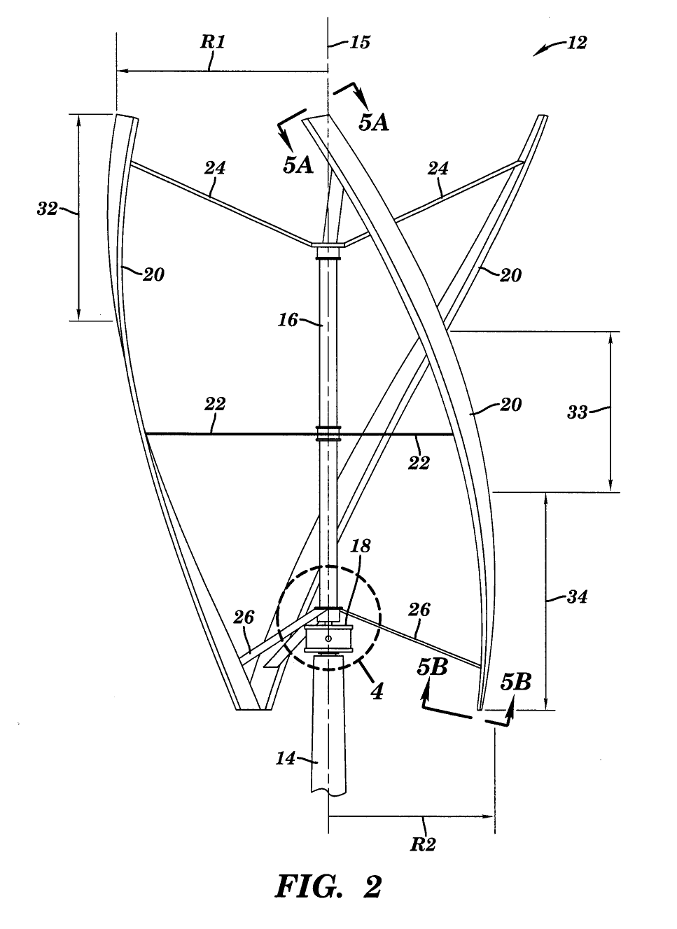

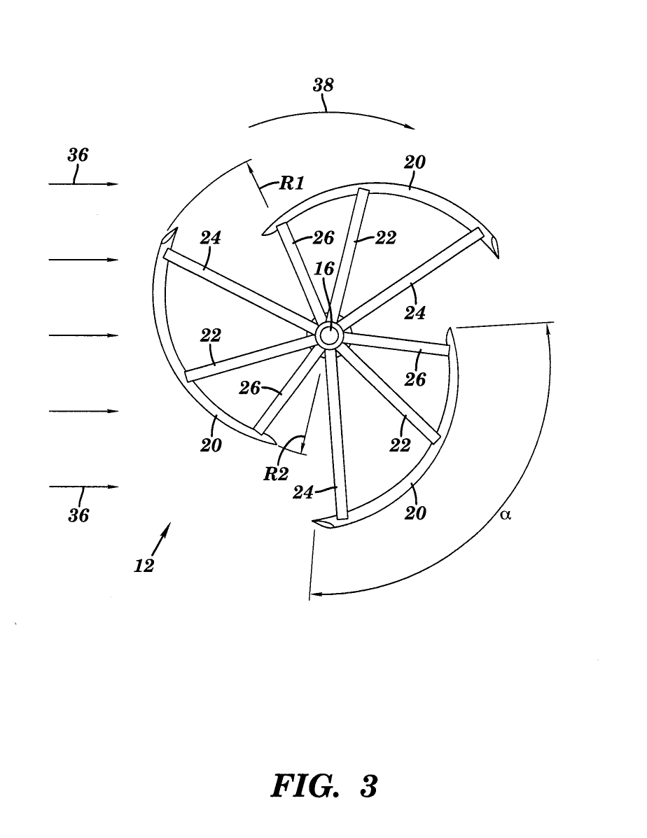

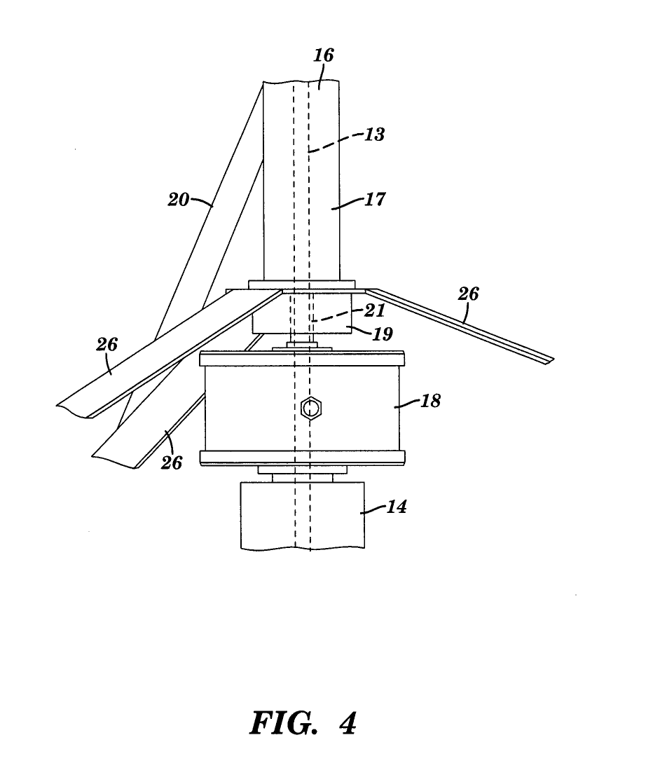

FIG. 2 is an elevation view of the wind turbine rotor 12 shown in FIG. 1 as indicated by Detail 2 in FIG. 1. FIG. 3 is a top plan view of the wind turbine rotor 12 shown in FIG. 2. As shown, according to aspects of the invention, rotor 12 includes a mast 16 rotatably coupled to an energy conversion device 18, for example, a generator, adapted to convert the rotational energy imparted to mast 60 to another form of energy, most typically, electrical energy. FIG. 4 is a detailed view of the rotor mounting shown in FIG. 2 as indicated by Detail 4 in FIG. 2. As shown most clearly in the detail of FIG. 4, mast 16 may typically comprise an elongated shaft 17 rotatably mounted about a central shaft 13 mechanically coupled, for example, keyed, to a drive shaft 21 of conversion device 18. Arms 22, 24, and 26 may be rigidly mounted to shaft 17 or mounted for rotation about a shaft 17, for example, by means of an anti-friction bearing 19. In one aspect, arms 22 and 26 may be rotatably mounted to shaft 17 and arms 24 may be rigidly mounted to shaft 17. Energy conversion device 18 is typically coupled to an energy collection and/or storage system, for example, to the local electrical grid or to a bank of batteries. This connection to the energy collection and/or storage system is not shown in FIG. 1 or 2. In one aspect of the invention, energy conversion device 18 may be a permanent magnet generator, or similar generator, which may be coupled to an inverter or to a related system to provide electrical energy, thought other types of energy conversion devices and storage systems may be used.

As shown in FIGS. 2 and 3, according to embodiments of the invention, rotor 12 includes a plurality of blades 20, for example, at least two, and typically at least three, blades 20 mounted to mast 16 whereby blades 20 rotate with mast 16. Though according to aspects of the invention blades 20 may be mounted to mast 16 by any conventional means, according to one aspect of the invention, each blade 20 may be mounted to mast 16 by at least one arm, support, or spindle 22, but typically at least two arms, supports, or spindles 22 and 24, for example, at least two arms 22 spaced along the length of blades 20. However, in the aspect of the invention shown in FIGS. 2 and 3, each blade 20 may be mounted to mast 20 by three supports: a middle support 22, a top support 24, and a bottom support 26. Supports 22, 24, and 26 may be of any suitable cross section, for example, circular, square, or rectangular, among others, while being adapted or configured to mount to mast 16 and blades 20.

In one aspect of the invention supports 22, 24, and 26 may be designed to enhance the efficiency of rotor 12. For example, one or more supports 22, 24, and 26 may be fashioned as an airfoil in cross section providing at least some lift to enhance the energy output of turbine 12. For instance, one or more supports 22, 24, and 26 may be cambered (or non-cambered) and provide an “angle of attack” to promote acceleration of rotor 12.

As shown most clearly in FIGS. 2 and 3, according to embodiments of the present invention, blades 20 may be mounted to mast 16 at varying radial distances. As shown in FIG. 2, according to one embodiment, the radial distance R1, or first radial distance, from the centerline 15 of mast 16 at an upper, top, or first end portion or section 32 of blade 20, for example, of each blade 20, may be greater than the radial distance R2, or a second radial distance, from centerline 15 at a lower, bottom or second end portion or section 34 of blade 20, for example, of each blade 20. A third or intermediate portion or section 33 may be positioned between first portion 32 and second portion 24. In one aspect of the invention, due to the shape and function of blades 20, turbine rotor 12 may be referred to as a “V-shaped Darrieus” turbine, a “V Darrieus” turbine, or a “hybrid V Darrieus” turbine.

According to the understanding of the inventors, the shorter radial distance of second radial distance R2 may be sufficient to provide “self-starting.” That is, in a manner similar to a Savonius-type turbine, the shorter or smaller radial distance R2 locates portion 34 at a radial distance where portion 34 can be accelerated, for example, from zero speed, under the influence of ambient wind, for example, without the need for a startup motor. In addition, the shorter radial distance R2 of portion 34 may provide an inherent “braking function” that can limit the speed of turbine 12 to prevent over speeding.

Also, according to aspects of the invention, the larger radial distance of first radial distance R1 may be sufficient to provide “lift” in a manner similar to a Darrieus-type turbine. For example, after initial startup due to “drag” upon the end portion 34 at smaller radial distance R2, the larger radial distance R1 may provide sufficient lift to accelerate turbine 12 to higher speed, for example, to at least an TSR of 2.0, or 3.0, and even 4.0 and higher. Again, according to aspects of the invention, run-away or overspending of turbine 12 may be limited by the drag provided by end portion 34 at radial distance R2. Accordingly, in one aspect of the invention, due to the shape and function of blades 20, turbine rotor 12 may be referred to as a “V-shaped, self-starting Darrieus” turbine or a “self-starting, hybrid V Darrieus” turbine.

Though the range of radial distances R1 and R2 may vary broadly according to aspects of the invention, R1 may be at least about 20% larger than R2, but is typically at least about 40%, and may be at least about 50% larger than R2. In one aspect of the invention, R1 may vary from about 0.5 meters (that is, on a 1 meter diameter) to about 10 meters (20 meter diameter), but is typically between about 1 meter (2 meter diameter) to about 3 meters (6 meter diameter). For example, in one aspect, R1 may be between about 1.6 meters (3.2 meters diameter) and about 1.8 meters (3.6 meters diameter). Similarly, in one aspect of the invention, R2 may vary from about 0.25 meters (that is, on a 0.5 meter diameter) to about 6 meters (12 meters diameter), but is typically between about 0.5 meters (1 meter diameter) to about 3 meters (6 meter diameter). For example, in one aspect, R2 may be between about 1 meter (2 meters diameter) and about 1.2 meters (2.4 meters diameter). The radial distance of the middle section of blade 20 between first end portion 32 and second end portion 34 will typically be consistent with the radial distances R1 and R2, for example, to provide a uniform linear or non-linear variation in radial distance between first end portion 32 and second end portion 34. As also shown in FIGS. 2 and 3, in one aspect, the extremities of blades 20 may be curved radially inward, for example, the extremities of blades 20 may be positioned at a radial distance less than the radial R1 or R2, respectively.

As shown most clearly in FIG. 3, rotor 12 under the influence of wind as indicated by vectors 36 typically rotates in the direction of arrow 38 (for example, clockwise in the view shown) where the upper portion 32 at radius R1 of each blade 20 leads the lower portion 34 at radius R2 during rotation. As shown in FIG. 3, according to aspects of the invention, blades 20 are typically uniformly curved from top to bottom from a maximum radial distance of about R1 to a minimum radial distance of about R2 of an arc length α [“alpha”]. The arc length a may vary from about 45 to 180 degrees, for example, depending upon the number of blades 20, but is typically between about 225 degrees to about 315 degrees, for example, between about 260 degrees to about 270 degrees.

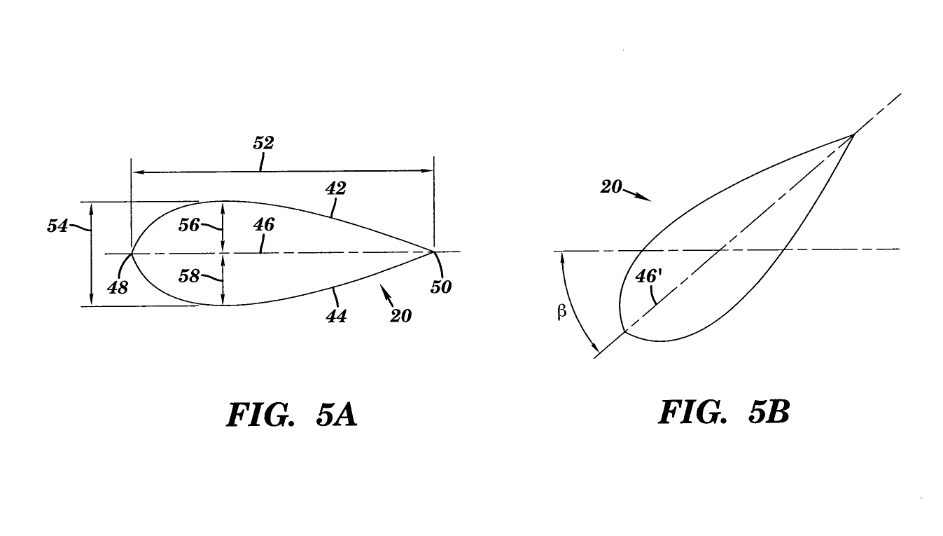

FIG. 5A and 5B are representative axial views of the rotor blade 20 shown in FIG. 2 as indicated by sections 5A-5A and 5B-5B, respectively, in FIG. 2. According to aspects of the invention, as shown in FIG. 5A, rotor blade 10 may typically have an airfoil shape or “tear drop” shape in cross section, that is, in axial cross section. As shown in FIG. 5A, and as is typical in the art, the airfoil shape of blade 20 may include upper surface 42, a lower surface 44, and a chord line 46 between a leading edge 48 and a trailing edge 50. As is also typical of the art, blade 20 includes a chord length 52, a thickness 54, an upper camber length 56, and a lower camber length 58. According to aspects of the invention, the cross section of blade 20 may have “camber,” that is, a difference between upper camber length 56 and lower camber length 58, or be “uncambered,” that is, where upper camber length 56 and lower camber length 58 are substantially equal in length. In another aspect of the invention, upper surface 42 or lower surface 44 may be planar, that is, surfaces 42 and 44 may be substantially flat, for instance, collinear with chord line 46.

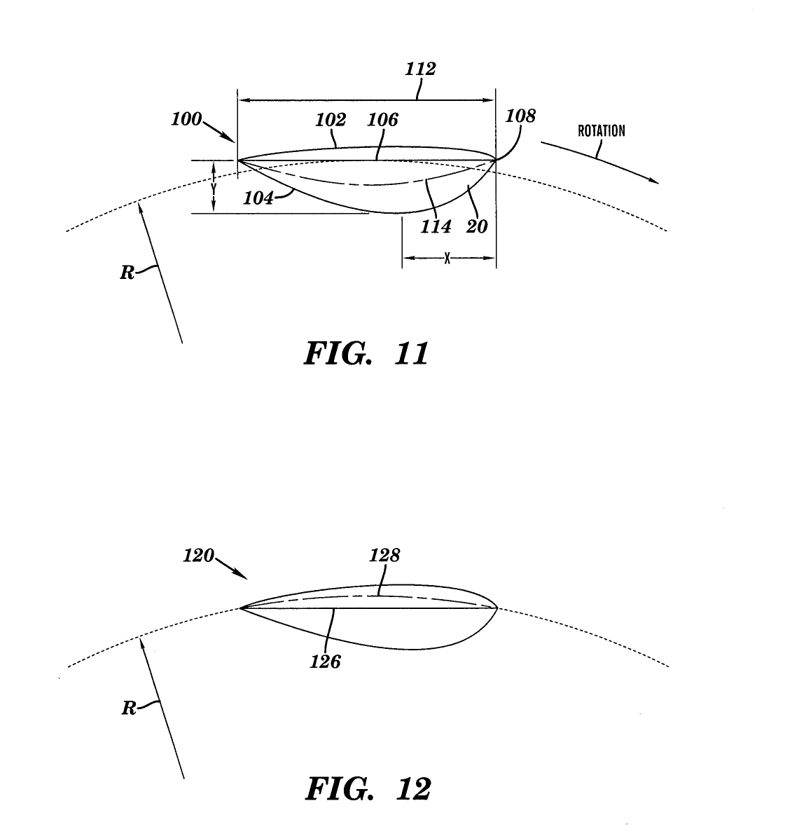

Further aspects of the geometry of rotor blade 20 according to aspects of the invention can be described with the assistance of FIGS. 11 and 12. FIG. 11 is a representative cross sectional view 100 of rotor blade 20 according to an embodiment of the invention as positioned at a radius R, for example, R1 or R2 of FIG. 2. As shown in FIG. 11, as in FIGS. 5A and 5B, blade 20 may an airfoil shape and include upper surface 102, a lower surface 104, and a chord line 106 (which may be tangent to radius R) between a leading edge 108 and a trailing edge 110. As is also typical of the art, blade 20 includes a chord length 112 and a camber mid-line 114 (that is, a line representing half the distance between upper surface 102 and lower surface 104).

As also shown in the FIG. 11, according to aspects of the invention, cross section 100 may have a maximum camber “y,” that is, a maximum distance between chord line 106 and surface 102 or 104 (depending upon the direction of camber; camber may be positioned toward the upper or outer surface 102 or toward the lower or inner surface 104) and the chord length “c” or 112. Cross section 100 may also have a location “x” of the maximum camber “y” from leading edge 108, that is, the distance from the leading edge 108 along chord line 102 to a perpendicular line from the location maximum camber “y” on surface 104 (or 102) to the chord line 106. According to the aspects of the invention, and as known in the art, cross section 100 may have a “camber” defined by the ratio, expresses as a percent, of the maximum camber “y” to the chord length “c,” that is,

camber=y/c in %

In addition, and as known in the art, cross section 100 may have a “camber position” defined by the ratio, expresses as a percent, of the distance “x” to the chord length “c,” that is,

camber position=x/c in %.

In one aspect, cross section 100, as shown in FIG. 11, may have a camber ranging from about 0 (or about 0.25) % to about 10%, for example, typically, ranging from about 0% to about 5%, and a camber position ranging from about 25% to about 35%. For example, the camber of one aspect of the invention may be expressed at “5% camber at 30% from the leading edge.”

FIG. 12 is a representative cross sectional view 120 of rotor blade 20 according to an embodiment of the invention as positioned at a radius R, for example, R1 or R2 of FIG. 2. Cross section 120 may have all the attributes of cross section 100 shown in FIG. 11. As shown in FIG. 12, cross section 120 may have a chord line 126 which may not be tangent to radius R. For example, as shown in FIG. 12, cross section 120 may have a mid-camber line 128 that may be substantially collinear or coincident with radius R, whereby mid-camber line 128 may have substantially the same radius as radius R.

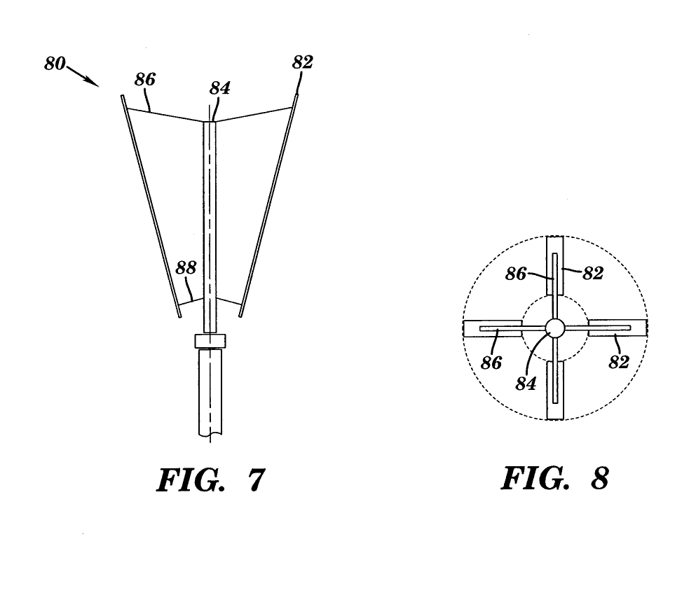

According to one aspect of the invention, blades 20 may be “helical” in shape, that is, twisted through an angle from top to bottom. This helical shape may be represented by the difference between the orientation of the views of blade 20 shown in FIGS. 5A and 5B represented by the angle β [beta.], that is, the angle between the chord line 46 shown in FIG. 5A and the chord line 46′ shown in FIG. 5B. That is, according to one aspect of the invention, the orientation of one end or extremity of blade 20 shown by view 5A-5A at the top of blade 20, as depicted in FIG. 5A, may vary from the orientation of a second end or extremity of blade 20 shown by view 5B-5B at the bottom of blade 20, as depicted in FIG. 5B. Though not shown, it is to be understood that the view of blade 20 shown in FIG. 5B comprises all the dimensions and characteristics described above for the view of blade 20 shown in FIG. 5A. According to aspects of the invention, the helical, helix, or twist angle β of blades 20 may vary from about 30 to about 90 degree, and is typically about 60 degrees from top to bottom, and may be a function of the number of blades 20. For example, in one aspect, angle β in degrees may be about equal to half the quotient of 360 degrees divided by the number of blades; for instance, a 3-bladed rotor may have an angle β of about 60 degrees; a 4-bladed rotor, 45 degrees; and a 5-bladed rotor, 36 degrees. In one aspect, as illustrated in FIGS. 7 through 10, β may be substantially 0, for example, blades 20 may have little or no twist and be substantially straight.

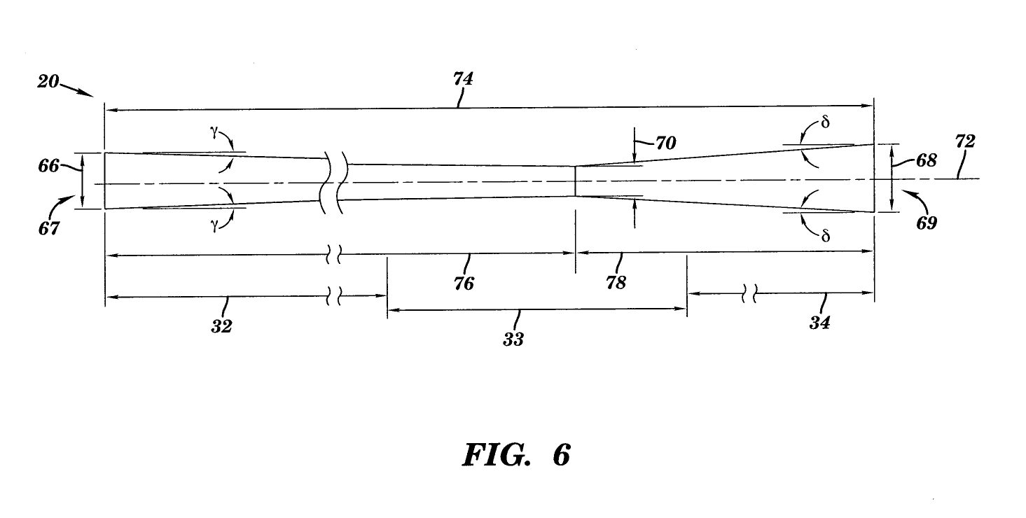

FIG. 6 is a developed view of a rotor blade 20 shown in FIG. 2 prior to bending into a helical shape, that is, prior to twisting blade 20 through angle β. As shown in

FIG. 6, according to an embodiment of the invention, blade 20 comprises at least two sections or portions, represented by lengths 32 and 34 (as also shown in FIG. 2), of varying chord length, that is, of varying chord length 52, as shown in FIG. 5A. In one embodiment, portion 32 of blade 20 has a first or top chord length 66 in portion 32, for example, at the end or extremity 67 of blade 20, and a second or bottom chord length 68, for example, in portion 34, for example, at the end or extremity 69 of blade 20, and a third or intermediate chord length 70 between ends 67 and 69, for example, between portions 32 and 34. According to one aspect of the invention, first chord length 66 may be larger, smaller, or about equal to second chord length 68; however, in one aspect, first chord length 66 is typically smaller than second chord length 68. In one aspect, intermediate or third length 70 may be larger or smaller than first chord length 66 and second chord length 68; however, in one aspect, third or intermediate chord length 70 is typically smaller then first chord length 66 and second chord length 68.

In one specific aspect of the invention, first chord length 66 may range in length from about 10 to 30 centimeters (cm), but is typically between about 10 cm and about 20 cm, for instance, about 15 cm. Second chord length 68 may range in length from about 10 to 30 cm, but is typically between about 15 cm and about 25 cm, for instance, about 20 cm. Third, or intermediate, chord length 70 may range in length from about 5 to 20 cm, but is typically between about 5 cm and about 15 cm, for instance, about 10 cm.

The thickness 54 (see FIG. 5A) of blade 20 may range from about 1 to about 10 cm, but is typically between about 2 cm and about 6 cm, for example, about 2 cm to about 4 cm. In one aspect, the thickness 54 may be defined as a percentage of chord length 52. For example, thickness 54 may vary from about 10% to about 30% of chord length 52, but is typically between about 15% to about 20% of chord length 54. For example, in one aspect, chord length 52 may be about 15.0 cm and blade thickness 54 may be about 20% of chord length 52, or about 3.0 cm.

As shown in FIG. 6, the variation in chord length in blade 20 may typically define an angle of convergence from the ends of blade 20, for example, vary linearly. For example, the convergence (or divergence) from the first or top chord length 66 may define and angle γ [gamma] and the convergence from the second or bottom chord length 68 may define an angle δ [delta.] The angles γ and δ may be substantially the same on either side of blade 20, for example, the chord length of blade 20 may vary uniformly and symmetrically about a centerline 72, however, the variation in chord length may also not be symmetric about centerline 72 where angle γ and/or angle δ may vary from one side of centerline 72 to the other side of centerline 72. In one aspect, angles γ and δ may range from about 0.5 degrees to about 5 degrees, but are typically between about 1 to about 3 degrees.

Though not shown in FIG. 6, the variation in chord length in blade 20 may vary non-linearly, for example, the shape of blade 20 may be defined by a curve or a combination of curves and linear features. For example, the convergence (or divergence) from the first or top chord length 66 to third chord length 70 of blade 20 may be defined by a curve, for example, a smooth quadratic or parabolic curve. Similarly, the convergence (or divergence) from the second or bottom chord length 68 to third chord length 70 may be defined by a curve, for example, a smooth curve. The curves may be substantially the same on either side of blade 20, for example, the chord length of blade 20 may vary symmetrically about centerline 72, however, the variation in chord length may also not be symmetric about centerline 72 where the curves on opposite sides of blade 20 may vary from a first curve on one side of centerline 72 to a second curve on the other side of centerline 72. In one aspect, the geometry of blade 20 may contain both linear variations and non-linear variations in chord length, for example, linear portions and curved portions along the length of blade 20.

Blade 20 may have an overall length 74 shown in FIG. 6; a length 76 between the top, end, or extremity 67 and the third or intermediate (for example, narrowest) chord length 70, and a length 78 between the bottom, end, or extremity 69 and the third or intermediate chord length 70. The lengths 76 and 78 may comprise a percentage of length 74, for example, length 76 may range from about 50% to about 80% of length 74, for example, about 75% of length 74; and length 78 may range from about 10% to about 50% of length 74, for example, about 25% of length 74. In one aspect, the overall length 74 may range from about 3 to about 10 meters, for example, between about 3 meters and 5 meters, for instance, about 4.3 to about 4.5 meters. The length 76 may vary from about 2 meters to about 6 meters, for example, between and 3 meters to about 4 meters, and the length 78 may vary from about 0.5 meters to about 2 meters, for example, about 1 to about 1.5 meters.

The dimensions of rotor 12 determine the “swept area” of the rotor, that is, the area bounded by the blades 20 as they rotate about mast 16 and defined by the height and diameter of blades 20. For example, in one aspect of the invention, rotor 12 may have a swept area of about 5 square meters to about 20 square meters, for instance, about 10 square meters.

Blades 12, mast 16, and spindles 22, 24, and 26, may be manufactures from any conventional structural material, for example, a metal, such as, iron, steel, stainless steel, aluminum, titanium, nickel, magnesium, brass, bronze, or any other structural metal. However, blades 12, mast 16, and spindles 22, 24, and 26 may typically be made from a lightweight material that is not susceptible to corrosion, for example, a plastic or a composite. In one aspect, blades 12, mast 16, and spindles 22, 24, and 26 may be fabricated from a re-enforced carbon fiber composite, or its equivalent. Due to the relatively high, varying, or reciprocating loading that VAWT experience in operation, rotor 20 and its components are typically designed to address the fatigue loading.

Rotor 20 may typically be designed for and operated at a maximum rotational speed ranging from about 10 to about 300 revolutions per minute [rpm], for example, for a speed of about 240 rpm. Rotor 20 may typically be designed for and operated at a maximum TSR ranging from about 2 to about 4, for example, for a TSR about 3.0 to about 4.0.

FIG. 7 is an elevation view of another wind turbine rotor 80 having a plurality of turbine blades 82 according to an embodiment of the invention. FIG. 8 is a top plan view of wind turbine rotor 80 shown in FIG. 7. In the aspect of the invention shown in FIGS. 7 and 8, blades 82 may not be helical or twisted, but may be substantially straight (that is, having an angle β of substantially zero). In addition, contrary to earlier embodiments, the portion of blades 82 having a larger radius is positioned at or adjacent to the top of rotor 80 and the portion of blades 82 having a smaller radius is positioned at or adjacent to the bottom of rotor 80. Blades 82 may be mounted to a central rotatable mast 84 by a plurality of supports, struts, or spindles 86 and 88. Blades 82 shown in FIGS. 7 and 8 may have all the attributes of rotor blades 20 described above, for example, varying chord length as shown in FIG. 6. In addition, rotatable mast 84 may have all the attributes of shaft 16 described above, and supports 86 and 88 may have all the attributes of supports 22, 24, and 26 mentioned above, for example, provide some lift to rotor 80, for example, due to camber.

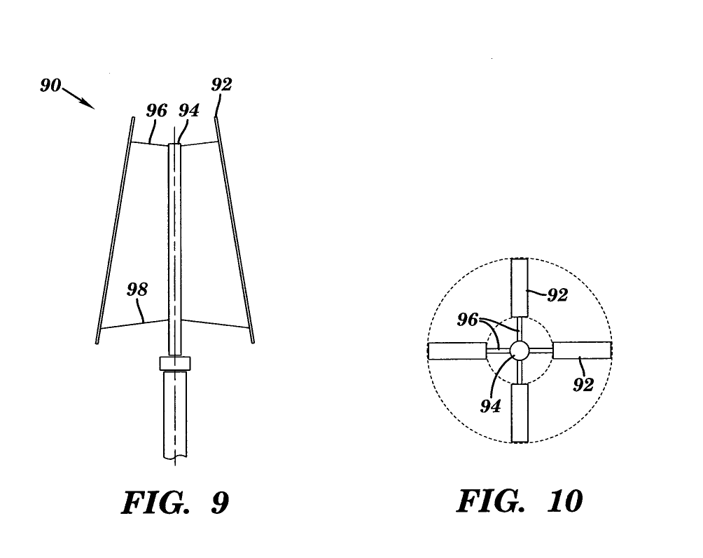

FIG. 9 is an elevation view of another wind turbine rotor 90 having a plurality of turbine blades 92 according to an embodiment of the invention. FIG. 10 is a top plan view of wind turbine rotor 90 shown in FIG. 9. In the aspect of the invention shown in FIGS. 9 and 10, blades 92 may not be helical or twisted, but may be substantially straight (that is, having an angle β of substantially zero). In addition, contrary to earlier embodiments, the portion of blades 92 having a larger radius is positioned at or adjacent to the bottom of rotor 90 and the portion of blades 92 having a smaller radius is positioned at or adjacent to the top of rotor 90. Blades 92 may be mounted to a central rotatable mast 94 by a plurality of supports, struts, or spindles 96 and 98. Blades 92 shown in FIGS. 9 and 10 may have all the attributes of rotor blades 20 described above, for example, varying chord length as shown in FIG. 6. In addition, rotatable mast 94 may have all the attributes of shaft 16 described above, and supports 96 and 98 may have all the attributes of supports 22, 24, and 26 mentioned above, for example, provide some lift to rotor 90, for example, due to camber.

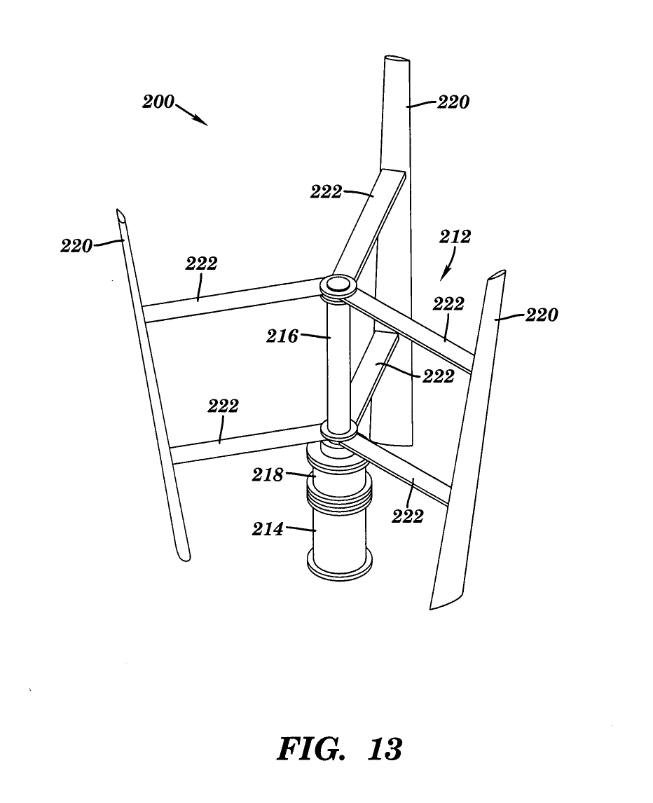

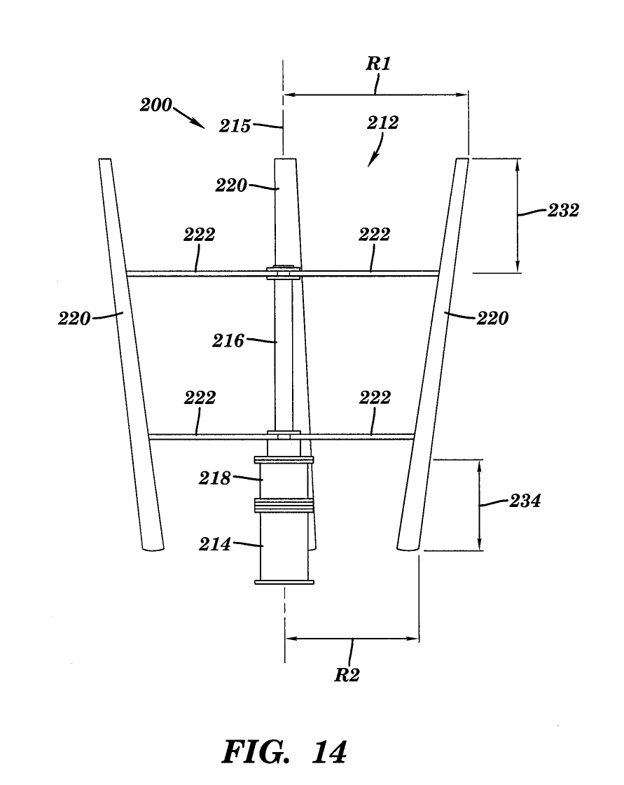

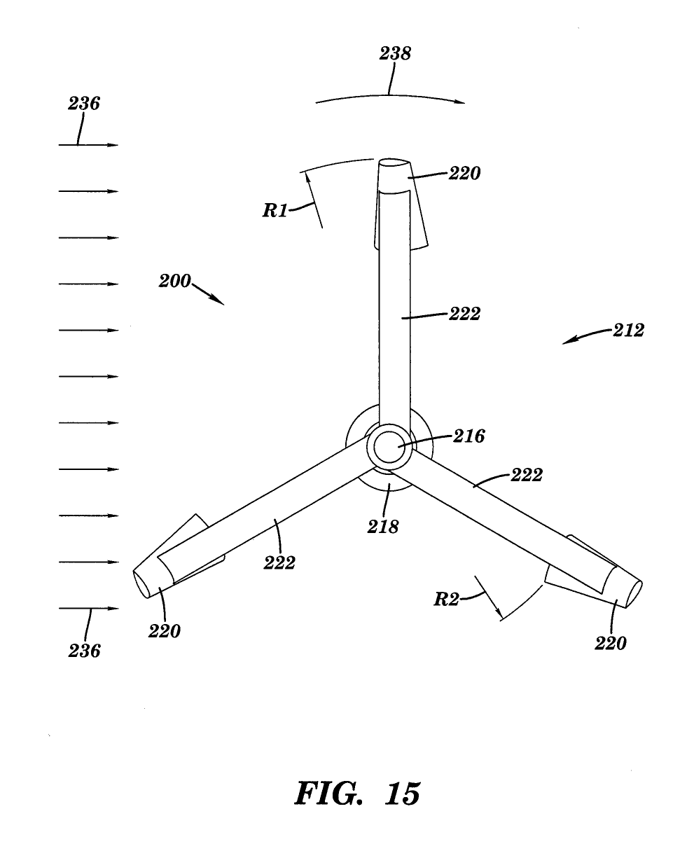

FIG. 13 is perspective view of a wind turbine assembly 200 according to another aspect of the invention. FIG. 14 is side elevation view of wind turbine assembly 200 shown in FIG. 13 and FIG. 15 is top plan view of wind turbine assembly 200 shown in FIG. 13. In a manner similar to wind turbine 10 shown in FIGS. 1-3, wind turbine assembly 200 having a rotor 212 having turbine blades 220. As is typical of the art, rotor 212 may be mounted on a pole, pyramid, or stanchion (not shown) in order to expose rotor 212 to the desired wind currents in order to generate the maximum amount of electrical energy. According to aspects of the invention, rotor 212 may be mounted on a stanchion (for example, a stanchion similar to stanchion 14 shown in FIG. 1) or may be mounted on any suitable structure, for example, to a rooftop of a building or home by conventional means, to expose rotor 212 to maximum wind energy.

As shown in FIGS. 13-15, according to this aspect of the invention, rotor 212 includes a mast 216 rotatably coupled to an energy conversion device 214, for example, a generator, adapted to convert the rotational energy imparted to mast 216 to another form of energy, most typically, electrical energy. As shown, energy conversion device 214 may be mounted between rotor mast 216 and a stanchion. In one aspect, one or more sensors may be mounted in a housing 218 mounted below mast 216, for example, a torque sensor or a speed sensor coupled to rotating mast 216. Though not shown in FIGS. 13-15, as is typical in the art, mast 216 may comprise an elongated shaft rotatably mounted about a central drive shaft mechanically coupled, for example, keyed, to a drive shaft of conversion device 214. (See FIG. 4 for an example of one coupling of mast 216 to conversion device 214.) Energy conversion device 214 may typically coupled to an energy collection and/or storage system, for example, to the local electrical grid or to a bank of batteries. This connection to the energy collection and/or storage system is not shown in FIGS. 13-15.

As shown in FIGS. 13-15, according to embodiments of the invention, rotor 212 includes a plurality of blades 220, for example, at least two, and typically at least three, blades 220 mounted to mast 216 whereby blades 220 rotate with mast 216. Though according to aspects of the invention blades 220 may be mounted to mast 216 by any conventional means, according to one aspect of the invention, each blade 220 may be mounted to mast 216 by at least one arm, support, or spindle 222, but typically may be mounted at least two arms, supports, or spindles 222, for example, at least two arms 222 spaced along the length of blades 220. Supports or arms 222 may be of any suitable cross section, for example, circular, square, or rectangular, among others, while being adapted or configured to mount to mast 216 and to blades 220.

As discussed above with respect to rotor 12, in one aspect of the invention, supports 222 may be designed to enhance the efficiency of rotor 212. For example, one or more supports 222 may be fashioned as an airfoil in cross section providing at least some lift to enhance the energy output of turbine 212. For instance, one or more supports 222 may be cambered (or non-cambered) and provide an “angle of attack” to promote acceleration of rotor 212.

As shown most clearly in FIG. 14, according to embodiments of the present invention, blades 220 may be mounted to mast 216 at varying radial distances. As shown in FIG. 14, according to one embodiment, the radial distance R1, or first radial distance, from the centerline 215 of mast 216 at an upper, top, or first end portion or section 232 of blade 220, for example, of each blade 220, may be greater than the radial distance R2, or a second radial distance, from centerline 215 at a lower, bottom or second end portion or section 234 of blade 220, for example, of each blade 220. In one aspect of the invention, due to the shape and function of blades 220, turbine rotor 212 may be referred to as a “V-shaped Darrieus” turbine, a “V Darrieus” turbine, or a “hybrid V Darrieus” turbine.

According to the understanding of the inventors, the shorter radial distance of second radial distance R2 may be sufficient to provide “self-starting.” That is, in a manner similar to a Savonius-type turbine, the shorter or smaller radial distance R2 locates portion 234 at a radial distance where portion 234 can be accelerated, for example, from zero speed, under the influence of ambient wind, for example, without the need for a startup motor. In addition, the shorter radial distance R2 of portion 234 may provide an inherent “braking function” that can limit the speed of turbine 212 to prevent over speeding.

Also, according to aspects of the invention, the larger radial distance of first radial distance R1 may be sufficient to provide “lift” in a manner similar to a Darrieus-type turbine. For example, after initial startup due to “drag” upon the end portion 234 at smaller radial distance R2, the larger radial distance R1 may provide sufficient lift to accelerate turbine 212 to higher speed, for example, to at least an TSR of 2.0, or 3.0, and even 4.0 and higher. Again, according to aspects of the invention, run-away or overspending of turbine 212 may be limited by the drag provided by end portion 234 at radial distance R2. In the aspect of the invention shown in FIGS. 13-15, the larger radius R1 is associated with the upper or top of turbine 212 and the smaller radius R2 is associated with the lower or bottom of turbine 212. However, in one aspect, this may be reversed while still providing the desired performance; that is, the larger radius R1 may be associated with the lower or bottom of turbine 212 and the smaller radius R2 may be associated with the upper or top of turbine 212

Though the range of radial distances R1 and R2 of rotor 212 may vary broadly according to aspects of the invention, R1 may be at least about 20% larger than R2, but is typically at least about 40%, and may be at least about 50% larger than R2. In one aspect of the invention, R1 may vary from about 0.5 meters (that is, on a 1 meter diameter) to about 10 meters (20 meter diameter), but is typically between about 1 meter (2 meter diameter) to about 3 meters (6 meter diameter). For example, in one aspect, R1 may be between about 1.6 meters (3.2 meters diameter) and about 1.8 meters (3.6 meters diameter). Similarly, in one aspect of the invention, R2 may vary from about 0.25 meters (that is, on a 0.5 meter diameter) to about 6 meters (12 meters diameter), but is typically between about 0.5 meters (1 meter diameter) to about 3 meters (6 meter diameter). For example, in one aspect, R2 may be between about 1 meter (2 meters diameter) and about 1.2 meters (2.4 meters diameter). Though not shown in FIG. 14, in one aspect, the extremities of blades 220 may be curved radially inward, for example, the extremities of blades 220 may be positioned at a radial distance less than the radial R1 or R2, respectively, whereby the radial distance R1 or R2 may reach a maximum at a distance distal the extremities of rotor blades 220.

As shown most clearly in FIG. 15, rotor 212 under the influence of wind as indicated by vectors 236 typically rotates in the direction of arrow 238 (for example, clockwise in the view shown) where the upper portion 232 at radius R1 of each blade 220 leads the lower portion 234 at radius R2 during rotation. As shown in FIG. 15, according to aspects of the invention, blades 220 are typically substantially straight, though blades 220 may be helical or curved for example, uniformly curved from top to bottom from a maximum radial distance of about R1 to a minimum radial distance of about R2, for example, over an arc length α [alpha] as shown FIG. 3.

Rotor blades 220 may be of substantially uniform chord length or the chord length of blades 220 may vary along the length of blades, for example, uniformly or linearly vary as shown in FIGS. 13-15, or vary as shown and described with respect to FIG. 6 above. For example, as shown in FIGS. 13-15, blades 220 may have a chord length at the top of blades 220, for example, in portion 232, of between about 100 and about 500 mm, preferably, from about 180 mm and about 220 mm, for instance, about 200 mm; and a chord length at the bottom of blades 220, for example, in portion 234, of between about 200 and about 600 mm, preferably, from about 330 mm and about 370 mm, for instance, about 350 mm.

Rotors 12, 80, 90, 212 may be provided with a protective cage or no cage may be present, depending upon the potential exposure of rotors 12, 80, 90, and 212 to contact. For example, rotor 12, 80, 90, or 212 may be provided with a removable, protective wire cage that prevents contact from objects, debris, animals, and humans with rotor 12, 80, 90, or 212 while permitting servicing and maintenance.

Aspects of the invention also comprise mounting and operating turbine rotors and rotor blades as shown and described. For example, aspects of the invention include the method of mounting blades 20 shown in FIGS. 1-6 on mast 16 or blades 220 shown in FIGS. 13-15 on mast 216 and operating turbine 20 or 220 in wind 36, 236 to produce or convert energy via energy conversion device 18, 218. Aspects of the invention also include the method of mounting blades 82 and 92 shown in FIGS. 7-10 on masts 84, 94 and operating turbine 80 or 90 in wind 36 to produce or convert energy via energy conversion device 18.

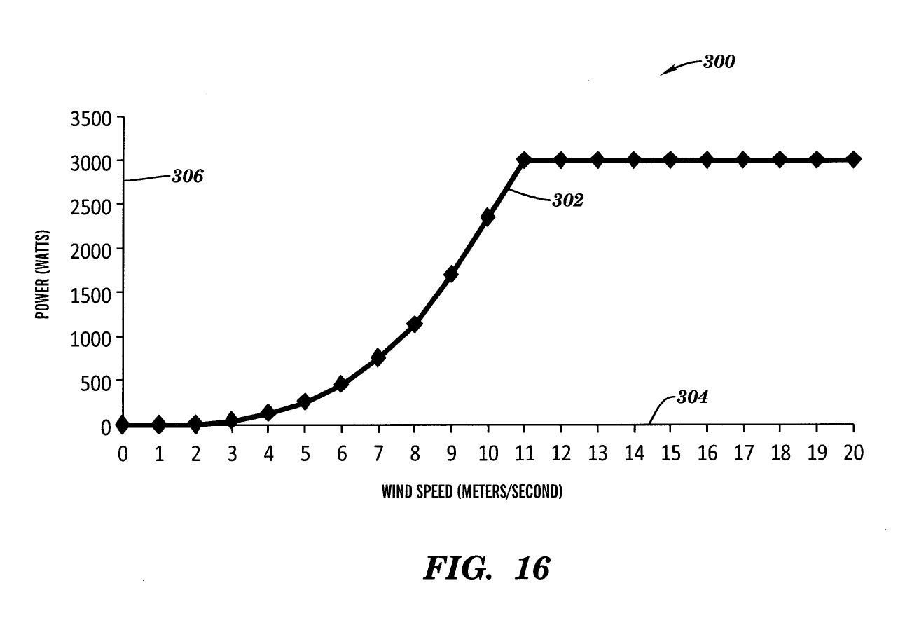

FIG. 16 is a graph 300 of a power curve 302 achievable at a given wind speed according to one aspect of the invention, for example, a rotor rated at 3 kW. As shown in FIG. 16, graph 300 includes a abscissa (x-axis) 304 of wind speed in meters per second (m/s) and an ordinate (or y-axis) 306 of corresponding power in watts (W).

Aspects of the present invention may have energy outputs ranging from about 1000 kilo-watt-hour per year (kW-h/y) to about 50,000 kW-h/y, and may typically have energy outputs ranging from about 1000 kW-h/y to about 20,000 kW-h/y, for example, ranging from about 2000 kW-h/y to about 8000 kW-h/y (for example, based upon class 2 to class 6 range of wind speeds, Rayleigh wind speed distribution). The rotor diameter may range from about 1 to about 10 meters, for example, between about 2.5 and about 3.5 meters, and the rotor height ranging from about 1 to about 10 meters, for example, between about 3 and 4 meters. Rotors according to aspects of the vision may have swept areas ranging from about 5 square meters to about 20 square meters, for example, about 10 square meters.

Aspects of the invention may typically have a rated wind speed of between about 5 and about 30 meters per second (m/s), for example, about 10 m/s to about 12 m/s; a cut-in speed ranging from about 1 m/s to about 6 m/s, for example, about 4 m/s; a cut-out speed ranging from about 10 m/s to about 30 m/s, for example, about 20 m/s; and a survival wind speed of between about 50 and about 80 m/s, for example, about 60 m/s.

Aspects of the present invention provide wind turbine rotors and wind turbine blades that combine the benefits and advantages of drag-type turbines and lift-type turbines in a single device. The varying radial positioning of the blades and the variation in chord length of the blades provide unique startup and performance characteristics that are not found in the prior art. As will be appreciated by those skilled in the art, features, characteristics, and/or advantages of the various aspects described herein, may be applied and/or extended to any embodiment (for example, applied and/or extended to any portion thereof).

Although several aspects of the present invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. A wind turbine rotor comprising:
a central elongated mast; and
a plurality of elongated blades, each of the plurality of elongated blades having a first portion and a second portion, the first portion mounted to the mast at a first radial distance from the mast and the second portion mounted to the mast at a second radial distance from the mast, less than the first radial distance.

2. The wind turbine rotor as recited in claim 1, wherein the first portion comprises a first end portion of each of the plurality of elongated blades and the second portion comprises a second end portion of each of the plurality of elongated blades opposite the first end portion.

3. The wind turbine rotor as recited in claim 2, wherein the first end portion comprises a first extremity of each of the plurality of elongated blades and the second end portion comprises a second extremity of each of the plurality of elongated blades opposite the first extremity.

4. The wind turbine rotor as recited in claim 1, wherein the first portion comprise a top portion of each of the plurality of elongated blades and the second portion comprises a bottom portion of each of the plurality of elongated blades opposite the top portion.

5. The wind turbine rotor as recited in claim 1, wherein each of the plurality of elongated blades comprises a first chord length in the first portion and a second chord length in the second portion, wherein the first chord length is less than the second chord length.

6. The wind turbine rotor as recited in claim 5, wherein the first portion of each of the plurality of elongated blades comprises an upper portion of each of the plurality of elongated blades.

7. The wind turbine rotor as recited in claim 5, wherein the plurality of blades comprise a uniform taper from the first chord length to the second chord length.

8. The wind turbine rotor as recited in claim 1, wherein the plurality of elongated blades comprises three elongated blades.

9. The wind turbine rotor as recited in claim 1, wherein the rotor further comprises a plurality of radial supports configured to mount the plurality of blades to the central mast.

10. The wind turbine rotor as recited in claim 9, wherein the plurality of radial supports provide at least some lift to the wind turbine rotor.

11. The wind turbine rotor as recited in claim 1, wherein the plurality of elongated blades are substantially straight blades.

12. A method of operating a wind turbine, the method comprising:
exposing a first portion of each of a plurality of blades positioned at a first radial distance from a central rotatable mast to wind wherein each of the plurality of blades is accelerated by the wind from substantially zero tangential velocity to a first tangential velocity greater than zero; and
exposing a second portion of each of a plurality the blades positioned at a second radial distance, greater than the first radial distance, from the central rotatable mast to the wind wherein each of the plurality of blades is accelerated by the wind to a second tangential velocity greater than the first tangential velocity.

13. The method as recited in claim 12, wherein the method is practiced with little or no energy input other than the wind.

14. The method as recited in claim 12, wherein the method is practiced with substantially no energy input other than the wind.

15. The method as recited in claim 12, wherein the method further comprises minimizing over speeding of the plurality of blades with the first portion of each of a plurality of blades positioned at a first radial distance from a central rotatable mast.

16. A wind turbine rotor comprising:
a central elongated mast;
a plurality of substantially radial supports mounted to the mast; and
a plurality of elongated blades mounted to the plurality of radial supports;
wherein at least one of the plurality of the radial supports is configured to provide at least some lift to the wind turbine rotor.

17. The rotor as recited in claim 16, wherein at least one of the plurality of radial supports comprise an airfoil having one of a cambered and a non-cambered shape.

18. A method of operating a wind turbine comprising:
rotatably mounting the wind turbine rotor recited in claim 1 to a structure; and
exposing the wind turbine rotor to a source of wind to accelerate rotation of the wind turbine rotor from a first rotational speed to a second rotational speed, greater than the first rotational speed;
wherein the second portion of at least one of the plurality of blades mounted at a second radial distance contributes at least some torque to the acceleration of the turbine rotor.

19. The method as recited in claim 18, wherein the first rotational speed comprises less than 5 rpm, wherein the method comprises a passive startup of the turbine rotor.

20. The method as recited in claim 19, wherein the first rotational speed comprises substantially zero rpm.
